(19) United States
(12) Patent Application Publication
(10) Pub. No.: US 2010/0059242 A1
(43) Pub. Date: Mar. 11, 2010

(54) PERCUSSION DEVICE

(75) Inventors: Antti Koskimäki, Tampere (FI); Ari Kotala, Tampere (FI)

Correspondence Address: DRINKER BIDDLE & REATH (DC), 1500 K STREET, N.W., SUITE 1100, WASHINGTON, DC, 20005-1209, US

(73) Assignee: SANDVIK MINING AND CONSTRUCTION OY, Tampere (FI)

(21) Appl. No.: 12/520,587

(22) PCT Filed: Dec. 19, 2007
(86) PCT No.: PCT/FI2007/050703

§ 371 Date: Jun. 22, 2009

(30) Foreign Application Priority Data
Dec. 21, 2006 (FI) 20065834

(51) Int. Cl. B25D 9/20; F01L 15/00

(52) U.S. Cl. 173/201; 91/189 A

(57) ABSTRACT

The invention relates to a percussion device having a body and a percussion piston moving therein, pressure fluid spaces in the rear and front ends of the percussion piston and pressure fluid channels for feeding pressure fluid into the percussion device. The percussion piston and the control valve comprise surfaces, which, when aligned, substantially close the pressure fluid flow from the pressure fluid space locating behind the percussion piston in front of the control valve, whereby the produced pressure displaces the control valve to another position.

### BACKGROUND OF THE INVENTION

The invention relates to a percussion device comprising a body and therein a percussion piston that moves longitudinally in a reciprocating manner by action of pressure fluid, in the body a first and a second pressure fluid space in the rear end and correspondingly in the front end of the percussion piston and a control valve that is substantially sleeve-like, locating around the rear end of the percussion piston and movably mounted in the longitudinal direction of the percussion piston, as well as pressure fluid channels for feeding pressurized pressure fluid in and out of the percussion device.

In pressure-fluid-operated percussion devices the reciprocating percussion movement of the percussion piston is controlled by a control valve that controls pressure fluid feed onto pressure surfaces of the percussion piston. In a known solution the control valve is located axially to the percussion piston in the rear end of the percussion piston. The position of the control valve in various stages of percussion is controlled by the position of the percussion piston with respect to the percussion device, and consequently as the percussion piston approaches its rear position it causes a change in the position of the control valve, typically by means of external pressure control or forced control by the effect of an increase in the pressure of the pressure fluid in a substantially closed space provided in the rear space of the piston. In the external pressure control, as the position of the percussion piston changes during the reverse stroke the percussion piston lets pressurized pressure fluid act on the control valve, which makes the control valve move from one position to another. In the forced control, a pressure rise in the rearmost pressure fluid space, in turn, results from the percussion piston compressing the pressure fluid while penetrating into the rearmost pressure fluid space, which is rendered substantially closed by the position of the percussion piston during the reverse stroke.

The external pressure control poses a problem that the valve moves slowly from one position to another. In the forced control solution, in turn, the position change of the valve is fast, but a problem is that the valve has a high final speed in both extreme positions of its movement. In addition, the pressure fluid in front of the valve flows directly into a tank, which decreases efficiency.

### BRIEF DESCRIPTION OF THE INVENTION

The object of the invention is to provide a solution, in which a valve position is made to change faster and more efficiently, and correspondingly, an efficient damping cushion solution will be provided for a percussion piston and a valve.

The percussion device of the invention is characterized in that in the rear end of the percussion piston there is an annular surface facing the control valve, and correspondingly, on the inner surface of the control valve there is an annular surface facing the percussion piston so that as the annular surfaces are aligned they substantially throttle the pressure fluid flow between the percussion piston and the control valve,

that as the reverse stroke of the percussion piston starts the control valve is in its rearmost position and closes access of the pressure fluid to a second pressure fluid space in the rear end of the percussion piston, whereby the pressure fluid is able to flow from the second pressure fluid space via a pressure fluid channel in front of the control valve away from the percussion device, and

that the percussion piston having shifted rearwardly to a predetermined position the annular surface in its rear end will be in alignment with the annular surface on the inner surface of the control valve, and consequently as the reverse stroke of the percussion piston continues the pressure in the second pressure fluid space rises decelerating the reverse stroke of the percussion piston and at the same time as pressure is acting on the surfaces on the side of the second pressure fluid space of the control valve it makes the control valve move towards the front end of the percussion device, whereby shoulders of the percussion piston and of the control valve will move apart so that the pressure fluid in the front end of the control valve will be able to flow into the second pressure fluid space in the rear end of the percussion piston and the control valve closes the pressure fluid flow through the channel out of the percussion device.

The basic idea of the invention is that the rear end of the percussion piston comprises an annular surface, and correspondingly, the interior of the valve comprises an annular surface, and as the surfaces become aligned a small clearance therebetween makes the pressure rise very fast in the rearmost cylinder space, as a result of which the valve moves fast to a second position, and correspondingly, a damping cushion is provided for the percussion piston. Further, the basic idea of the invention is that from the annular surface of the percussion piston towards the front end of the percussion piston there is a flow channel for at least the travel of the annular surface of the valve so that the annular surface of the valve having moved in front of the surface of the percussion piston there is a clearance between the valve surface and the percussion piston, through which the pressure fluid in front of the valve is able to flow from the front side of the valve to a cylinder space further back.

The solution of the invention has an advantage that the efficiency of the percussion device improves, because as a result of the control valve movement the pressure fluid in front thereof is able to move between a groove in the percussion piston and a protrusion in the control valve into the rearmost pressure fluid space of the percussion device, i.e. into a work space, and it is not made to flow into the pressure fluid container. Further, the valve speed is damped without a separate damping cushion.

### BRIEF DESCRIPTION OF THE DRAWINGS

In the following the invention will be described in greater detail in connection with the attached drawings, in which

FIG. 1 is a schematic view of a prior art percussion device,

FIGS. 2a to 2d show the percussion device of the invention in various stages of percussion movement,

FIGS. 3a and 3b show an embodiment of a percussion piston applicable for implementing the invention, and

FIGS. 4a and 4b show an embodiment of a control valve applicable for implementing the invention.

### DETAILED DESCRIPTION OF SOME EMBODIMENTS OF THE INVENTION

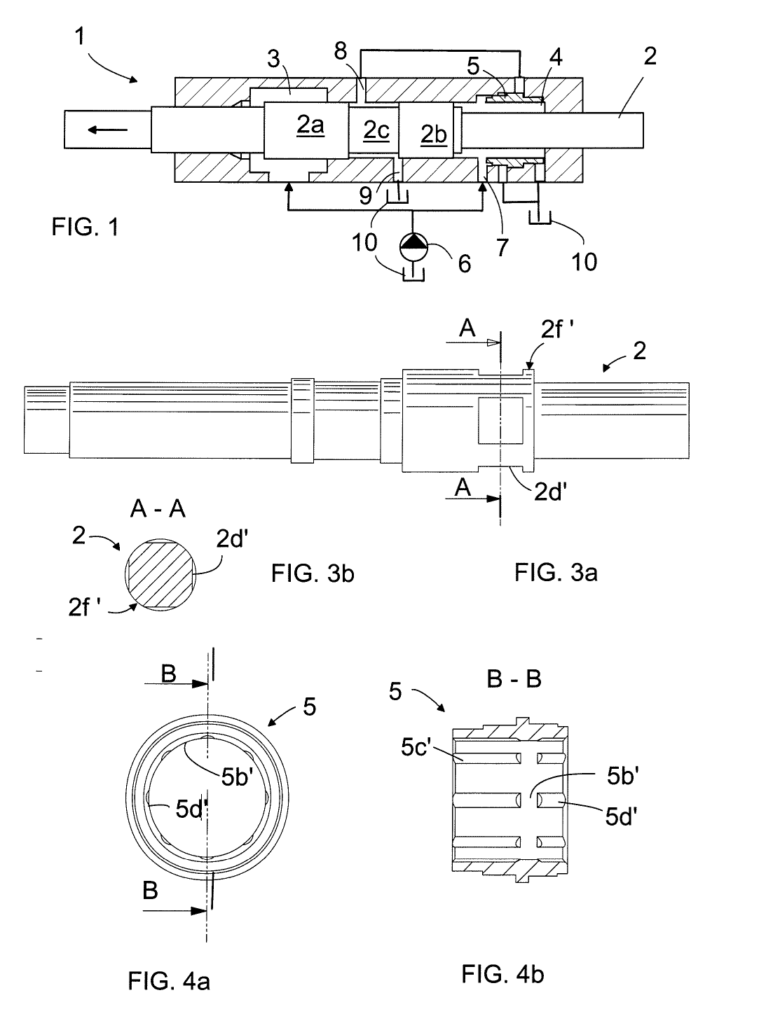

FIG. 1 shows schematically a known percussion device solution. It comprises a percussion device 1, inside which a percussion piston 2 moves in a reciprocating manner. The percussion piston 2 comprises shoulders 2a and 2b and between them there is an annular groove 2c, by means of which the operation of the percussion device is controlled. In the front end of the percussion device there is a first pressure fluid space 3 and in the rear end a second pressure fluid space 4. Inside the pressure fluid space 4 there is a control valve 5 axially to the percussion piston. Pressure fluid is fed from a pressure fluid pump 6 to the first pressure fluid space 3 of the percussion device continuously and to the second pressure fluid space via a channel 7, controlled by the control valve 5, periodically. In the percussion device body there is also a second pressure fluid channel 8 and a third pressure fluid channel 9, which is communicating with a pressure fluid container 10. The second pressure fluid channel 8 is connected to the control valve 5, whereby the pressure acting therein causes the control valve to move from one position to another.

In the situation shown in FIG. 1 the percussion piston 2 is moving forwardly in the direction of the arrow. The control valve 5 is in its rearmost position, i.e. on the right in the situation depicted in FIG. 1, and the pressure fluid is able to flow from the pressure fluid pump 6 via the channel 7 to the second, i.e. the rearmost, pressure fluid space 4, pushing the percussion piston forwardly. Substantially zero pressure prevails in the channel 8, because the channel 8 is connected via the groove 2c to the pressure fluid container 10. At the same time the control valve 5 is also substantially subjected to zero pressure, and consequently the control valve remains immobile.

As the percussion piston moves forwardly in the travel direction, the shoulder 2b closes the channel 9 and thus separates the space formed by means of the groove 2c from the pressure fluid container 10. As the percussion piston moves further forwardly, a connection is provided from the first pressure fluid space 3 through the groove 2c to the channel 8, whereby the pressure in the pressure fluid also acts on the control valve 5 and makes it change the position.

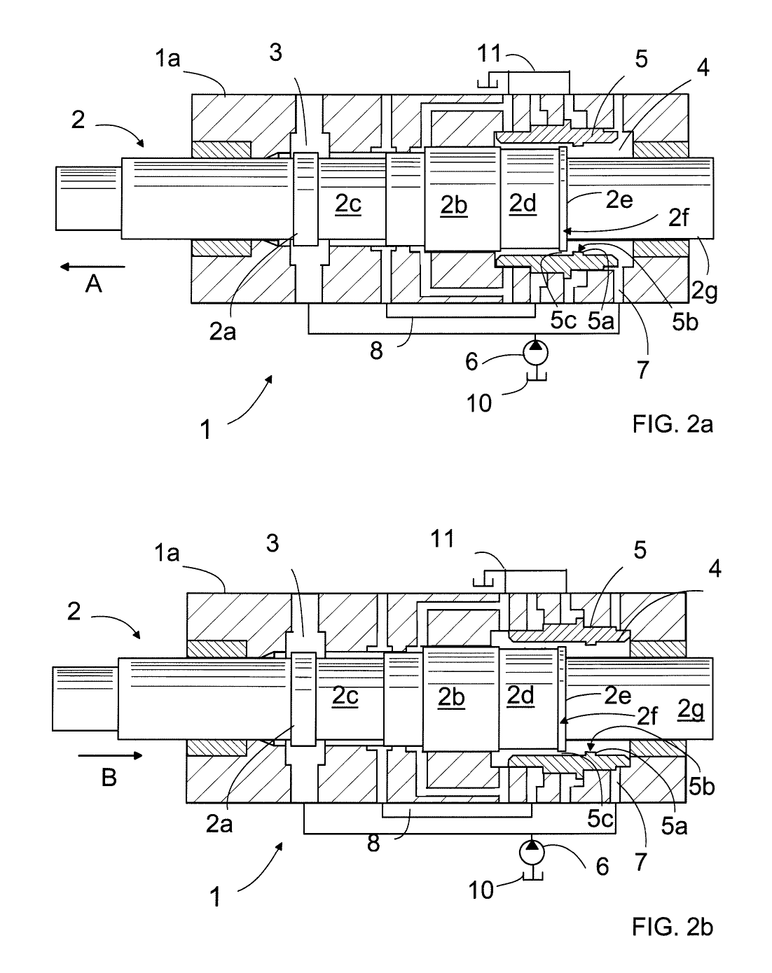

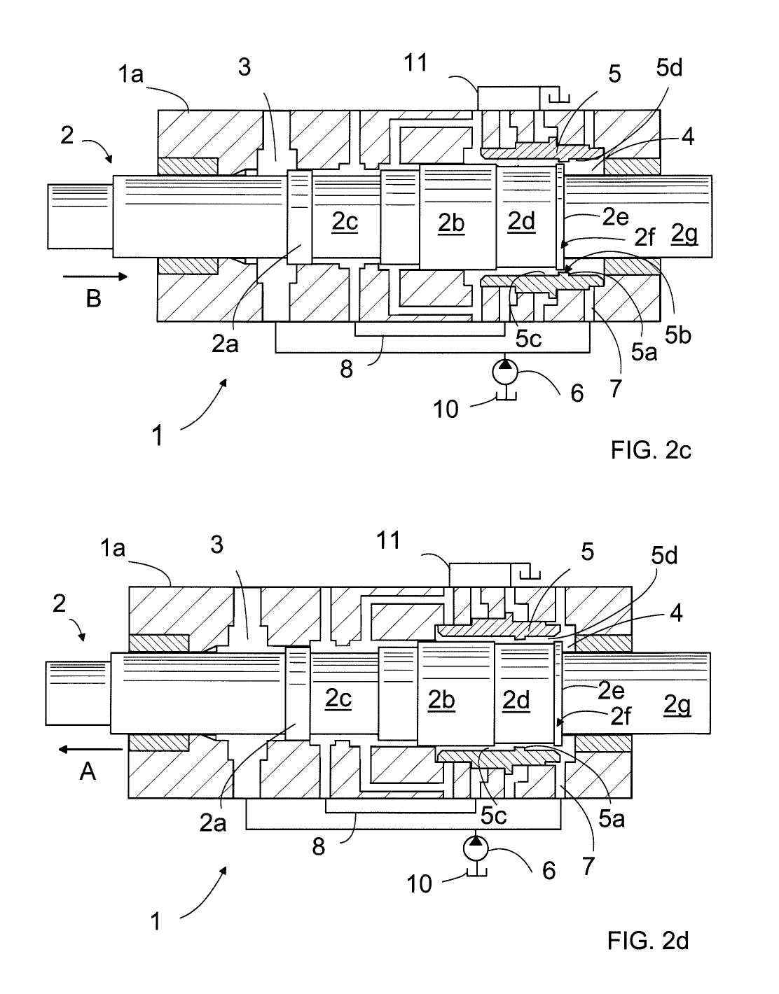

FIGS. 2a to 2d show the operation of the percussion device in accordance with the invention in different stages of movement. In these figures, like reference numerals refer to like parts as indicated in FIG. 1.

FIG. 2a shows a situation in which the percussion piston is in its nearly foremost position as its moves in the direction of striking, i.e. in the direction of arrow A. The control valve 5 is in its foremost position, in which the pressure of the pressure fluid acts on the back surface of the rearmost shoulder 2b of the percussion piston 2. At the same time, however, the pressure in the pressure fluid from the first pressure fluid space 3 is able to act on the control valve 5 via the groove 2c and further via the channel 8, whereby the control valve changes its position to that shown in FIG. 2b closing the pressure fluid access to the second pressure fluid space 4. As a result, the percussion piston 2 starts moving in the reverse direction indicated by arrow B and the pressure fluid is able to discharge between the control valve 5 and the annular groove 2b in the rear end of the percussion piston 2 and via the channel 11 to the pressure fluid container 10.

During the reverse stroke of the percussion piston 2 the shoulder 2a closes communication from the first pressure fluid space via the groove 2c to the channel 8 and therethrough to the control valve. Thus the pressure in the pressure fluid stops acting on the control valve 5.

The percussion piston, in the rear end behind the shoulder 2b thereof, comprises an annular groove, i.e. a flow channel 2d, in the second end of which, i.e. the rear end away from the shoulder 2b, there is a narrow shoulder 2e having an annular surface 2f. Further, the percussion piston may comprise a separate part 2g forming an extension in the rear end, but it is not necessary or relevant to the invention. The percussion piston may be without the extension 2g or the length and cross sectional area of the extension may vary in a manner known per se. The cross sectional area of the extension may be graded in a variety of ways without that affecting the invention in any way.

On the inner side of the control valve 5 there is a shoulder 5a facing the piston 2 and having an annular surface 5b. The inner diameter of the control valve 5 from the shoulder 5a towards the front end of the percussion device 1 is larger than the inner diameter of the shoulder 5a and an annular flow channel 5c is formed from the shoulder 5a up to the front end of the control valve 5.

As the percussion piston 2 has reached, during its reverse stroke, the position shown in FIG. 2c, in which the shoulder edges and thus the annular surfaces 2f and 5b are aligned, there is only a small clearance between the shoulders 2e and 5a, which provides a throttle for the pressure fluid flow. As a result, the pressure fluid flow from the second pressure fluid space, between the percussion piston 2 and the control valve 5, via the channel 9 to the pressure fluid container 10 will be considerably reduced or substantially prevented. So, as the percussion piston protrudes into the rearmost, i.e. the second pressure fluid space 4, a sudden high pressure is created therein. Thus, there is also created a damping cushion filled with pressure fluid, which dampens the reverse motion of the percussion piston 2, as high pressure, when acting on the surfaces of the control valve 5 facing the second pressure fluid space 4, makes the control valve 5 move fast to the front position, i.e. the position shown in FIG. 2a.

When the annular surfaces 2f and 5b of the shoulders 2e and 5a have passed one another, the pressure fluid displaced by the control valve 5 is able to flow from the front end of the control valve to the second pressure fluid space 4 via the flow channel 5c and the flow channel 2e, respectively, and it need not flow into the pressure fluid container 10. If the protrusion 5a is, as shown in FIGS. 2a to 2d, between the ends of the control valve 5, there has to be a flow channel also in the rear part of the control valve 5, i.e. from the shoulder 5a to the rear end of the control valve 5. By way of example, in this case it is formed in such a manner that the inner diameter of the control valve 5 extending from the shoulder 5a towards the rear end of the percussion device 1 is larger than the inner diameter of the shoulder 5a, whereby an annular flow channel 5d is formed from the shoulder 5a to the rear end of the control valve 5. When the shoulder 5a is in the rear end of the control valve 5, no separate flow channel will be needed, naturally.

In the situation shown in FIG. 2d, the percussion piston 2 is in its rearmost position and the control valve 5 has moved to its foremost position. In this situation the percussion piston 2 starts moving again forwardly in the direction of arrow A and the working cycle continues in the above described manner.

FIGS. 3a and 3b show an alternative embodiment of the percussion piston, which is applicable for use in accordance with the invention. In this embodiment there is not an annular groove extending around the whole percussion piston between the shoulder 2b and the annular surface 2f, but by way of example, it is provided with four or more longitudinal grooves that constitute flow channels 2d′ and via which the pressure fluid is able to flow between the protrusion 5a of the control valve 5 and the percussion piston 2. Otherwise the structure and operation of the percussion piston are similar to those shown in FIGS. 2a to 2d. FIG. 3b depicts the form of the grooves 2d′ as a cross section A-A of the percussion piston.

FIGS. 4a and 4b, in turn, show an embodiment of the control valve, which is also applicable to the percussion device of the invention. In this embodiment on the inner surface of the control valve 5 there are provided longitudinal grooves that constitute flow channels 5c′, via which the pressure fluid is able to flow. On the inner surface of the control valve 5 there is a continuous, annular surface 5b′, which cooperates with the annular surface 2f or 2f′ of the percussion piston 2. It also comprises longitudinal grooves that constitute flow channels 5d′ rearwardly from the annular surface 5b′.

The invention is described in the above specification and the drawings only by way of example and it is by no means restricted thereto. From the viewpoint of the invention it is substantial that the percussion piston and the control valve comprise narrow, annular surfaces, preferably shoulders, which when in alignment form a nearly closed space providing a high pressure in the pressure fluid behind the percussion piston and, on the other hand, the surfaces, such as the shoulders, having passed one another, the flow channels, such as the annular grooves, allow the pressure fluid displaced by the control valve to flow into the pressure fluid space behind the percussion piston.

1. A percussion device comprising a body and therein a percussion piston that moves longitudinally in a reciprocating manner by action of pressure fluid, in the body a first and a second pressure fluid space in the rear end and correspondingly in the front end of the percussion piston, and a control valve that is substantially sleeve-like, locating around the rear end of the percussion piston and movably mounted in the longitudinal direction of the percussion piston, as well as pressure fluid channels for feeding pressurized pressure fluid in and out of the percussion device, wherein
in the rear end of the percussion piston there is an annular surface facing the control valve, and correspondingly, on the inner surface of the control valve there is an annular surface facing the percussion piston so that as the annular surfaces are aligned they substantially throttle the pressure fluid flow between the percussion piston and the control valve,
as the reverse stroke of the percussion piston starts the control valve is in its rearmost position and closes access of the pressure fluid to a second pressure fluid space in the rear end of the percussion piston, whereby the pressure fluid is able to flow from the second pressure fluid space via a pressure fluid channel in front of the control valve away from the percussion device, and
the percussion piston having shifted rearwardly to a predetermined position the annular surface in its rear end will be in alignment with the annular surface on the inner surface of the control valve, and consequently as the reverse stroke of the percussion piston continues the pressure in the second pressure fluid space rises decelerating the reverse stroke of the percussion piston and at the same time as pressure is acting on the surfaces of the control valve on the side of the second pressure fluid space of the control valve it makes the control valve move towards the front end of the percussion device, whereby the annular surfaces of the percussion piston and of the control valve will move apart so that the pressure fluid in the front end of the control valve is able to flow into the second pressure fluid space in the rear end of the percussion piston and the control valve closes the pressure fluid flow through the channel out of the percussion device.

2. The percussion device of claim 1, wherein as the annular surfaces are aligned there is a slot between them, which throttles the pressure fluid flow between the percussion piston and the control valve.

3. The percussion device of claim 1, wherein the percussion piston and the control valve comprise, from the annular surfaces towards the front end of the percussion device, mutually aligned flow channels through which the pressure fluid is able to flow between the percussion piston and the control valve.

4. The percussion device of any one of claims 1 to 3 and 9, wherein in the rear end of the percussion piston there is an annular protrusion whose outer surface forms an annular surface and from the protrusion towards the front end of the percussion piston there is an annular flow channel.

5. The percussion device of any one of claims 1 to 3 and 9, wherein in the rear end of the percussion piston there is an annular surface and from the surface towards the front end of the percussion piston at least one flow channel is provided in the percussion piston.

6. The percussion device of any one of claims 1 to 3 and 9, wherein on the inner surface of the control valve there is an annular protrusion whose outer surface forms an annular surface and that from the protrusion towards the front end of the percussion device the inner diameter of the control valve is larger than the inner diameter of the protrusion such that an annular flow channel will be provided.

7. The percussion device of any one of claims 1 to 3 and 9, wherein on the inner surface of the control valve there is an annular surface and that from the annular surface towards the front end of the percussion device at least one flow channel is provided on the inner surface of the control valve.

8. The percussion device of any one of claims 1 to 3 and 9, wherein the annular surface of the control valve is between the ends of the control valve and that from the annular surface towards the rear end of the control valve there is provided at least one flow channel.

9. The percussion device of claim 2, wherein the percussion piston and the control valve comprise, from the annular surfaces towards the front end of the percussion device, mutually aligned flow channels through which the pressure fluid is able to flow between the percussion piston and the control valve.

10. The percussion device of claim 5, wherein on the inner surface of the control valve there is an annular protrusion whose outer surface forms an annular surface and that from the protrusion towards the front end of the percussion device the inner diameter of the control valve is larger than the inner diameter of the protrusion such that an annular flow channel will be provided.
